(19) United States
(12) Patent Application Publication
(10) Pub. No.: US 2026/0149565 A1
(43) Pub. Date: May 28, 2026

(54) METHOD AND SYSTEM FOR REDUCTION OF CIPHERTEXT MATRIX COMPUTATION AND BOOTSTRAPPING IN SECURE LLM

(71) Applicant: Cornami, Inc., Dallas, TX (US)

(72) Inventor: Fa-Long LUO, Dallas, TX (US)

(21) Appl. No.: 19/400,724

(22) Filed: Nov. 25, 2025

Related U.S. Application Data
(60) Provisional application No. 63/724,512, filed on Nov. 25, 2024.

(51) Int. Cl. H04L 9/06; H04L 9/00

(52) U.S. Cl. CPC H04L 9/0618; H04L 9/008

(57) ABSTRACT

The disclosure is directed toward a method and system to efficiently determine an attention function by reducing bootstrapping steps and ciphertext matrix operations. A combined key and query matrix in plaintext is pre-calculated. A ciphertext-plaintext matrix multiplication of the combined key and query matrix with a ciphertext input is performed. The output of the resulting ciphertext-plaintext matrix multiplication of the combined key and query matrix is bootstrapped. A ciphertext-plaintext matrix multiplication of the value matrix with the ciphertext input is performed. The resulting ciphertext-plaintext matrix multiplication of the value matrix is bootstrapped.

### PRIORITY CLAIM

The present disclosure claims priority from and the benefit of U.S. Provisional Ser. No. 63/724,512, filed Nov. 25, 2024. The contents of that application are hereby incorporated by reference in their entirety.

### TECHNICAL FIELD

The present disclosure relates generally to protection of proprietary large language models. More particularly, aspects of this disclosure relate to using a pre-calculated combined key and query matrix in plaintext for ciphertext matrix operations to reduce bootstrapping steps for encryption of large language models.

### BACKGROUND

Large Language Models (LLMs), also known as generative Artificial Intelligence (Gen AI), transformers, or Natural Language Processing (NLP), have now become, in a very short space of time, a foundational artificial intelligence technique. They provide human level intelligence across the knowledge base they are trained upon. The key metric, which is proportional to the amount of knowledge they hold, is the number of parameters or weights that they hold. Very large models start in the low billions of parameters moving up to the low trillions of parameters. The training sets on the largest models can comprise the entirety of the accessible internet.

Using existing pretrained LLMs as a starting point it is possible to perform additional training using very specific knowledge to produce LLMs that are experts in the narrow knowledge domain. This process of taking an existing LLM and continuing its training is known as fine-tuning. Fine tuning involves taking a pre-existing model that has been trained on a large dataset, such as a language model like GPT-3, and refining it for a specific task or domain. During fine-tuning, the model is further trained on a smaller, domain-specific dataset. This process adapts the model parameters to the nuances of the target task, thus improving performance and making the model more capable in handling specific tasks. Fine-tuning is a cost-effective and efficient way to leverage the knowledge learned by a pre-trained model while tailoring the model to specific applications, reducing the need for extensive training from scratch. Since the most compute intensive operations have already been performed in the development of the initial model, the fine-tuning process only requires a small percentage of the weights to be modified to incorporate the additional, expert level information. Typically, only 1/100 to 1/10,000 of the exiting parameters need to be modified. This has proven to be a game-changer in many information processing tasks, allowing for rapid development of domain specific AI solutions with high accuracy and applicability.

Training and inference are two crucial phases in the lifecycle of Large Language Models (LLMs), such as GPT-3. These models are pre-trained on vast corpora of text data and then fine-tuned for specific tasks before they can be effectively deployed for real-world applications.

The training of LLMs is a computational resource-intensive process that typically involves two main steps: pre-training, which requires the majority of the computational resources and fine-tuning. During pre-training, the model is exposed to a massive amount of text from the internet, learning to predict the next word in a sentence. This helps the model acquire a vast amount of world knowledge and linguistic patterns. The training process involves updating billions of model parameters using powerful computational resources, typically state of the art NVIDIA GPUs, which can take days, weeks or even months to complete. Following pre-training, fine-tuning is performed on a narrower dataset with labeled examples for a specific task, such as a company's intellectual property. Fine-tuning adapts the model parameters to the target task, making it more effective and contextually relevant. Fine-tuning is a critical step that tailors the LLM for practical applications taking from human level to expert level intelligence.

Once an LLM has been trained and fine-tuned, the trained and fine-tuned LLM can be used for inference, which involves making predictions or generating text for specific tasks. During inference, input data, typically in the form of text, is fed into the model. The model processes the input, generates output, and provides predictions or text generation. Inference can be performed both in real-time applications and non-real-time applications. Real-time applications are sensitive to latency, such as chatbots, language translation services, content generation, and more. Non-real-time applications, such as batch processing of document, information, software, hardware designs and the like are not sensitive to latency. The LLMs are deployed on high computational powered cloud servers in data centers, or in a private data center of a company, which enables deployment to all the employees of the company, software as a service to paying customers, or even access on the general Internet. Inference with LLMs is revolutionizing industries by automating tasks that previously required a human expert.

The issue with producing expert-level fine-tuned LLM is that they, by definition, must include valuable proprietary information. The entirety of expertise, intellectual property, knowledge base, trade secrets, and confidential information of a company from inception to the present time can be incorporated into a fine-tuned LLM. Thus, there are four existing problems with fine-tuned LLMs. Two of these problems are on the inference portion of the fine-tuned LLM. First, from the perspective of the owner of the fine-tuned LLM model, the theft of one of these fine-tuned LLM is catastrophic. The LLM can enable competitors to produce products or offer services that compete with the owners' business. Alternatively, if the LLM is simply released on the Internet, the revenue of the original company may be driven to zero. Thus, there is a need to prevent the use by unauthorized third parties of a fine-tuned LLM.

Second, a user of these LLMs is providing queries to the fine-tuned LLM and receiving results from these queries. The queries may contain intellectual property of the user and the answers to these queries may contain new and novel intellectual property that the owner of the fine-tuned LLM now has access to. There is a need to prevent the leakage of intellectual property of a user into the LLM from the queries as well as protect any new and novel intellectual property in the responses form the LLM.

The training portion of the fine-tuned LLM also presents two problems. First, the training of the fine-tuned parameters is typically performed using plain-text or human readable data. The fine-tuned parameters must be protected from theft or disclosure by either external parties or even internal employees during this entire process. There is a need to protect against the theft of the plaintext LLM data as it is undergoing fine-tuning. Second, the information that is used for the fine-tuning process may be highly sensitive, proprietary, classified or protected under privacy laws such as the European GDPR rules or the HIPPA rules in the US.

Thus, current solutions to these problems require encryption of the weights of the LLM as well as the inputs to the LLMs. The encryption protects the valuable weights as well as input inquires and responses.

Currently, encryption techniques relate to public/private key mechanisms that require an intensive level of computing power to brute force solve the encryption. Such systems are currently secure because of the corresponding intensive level of computing power necessary to solve such encryption. However, with the advent of potential quantum computers, standard encryption techniques may be vulnerable to being solved by a quantum computer. Thus, new types of quantum secure encryption have been proposed, such as fully homomorphic encryption (FHE). FHE allows computations on ciphertext without having to perform decryption. This allows delegation of sensitive data analysis computations on encrypted data. The FHE allows computations such a Boolean operation, Integer arithmetic operation, Floating-point arithmetic operation on ciphertext without decryption. Thus, sensitive data analysis (computations) may be performed on encrypted data without ever decrypting the data. There are several open-source frameworks of fully homomorphic encryption one such framework is the Concrete library that implements the Fully Homomorphic Encryption over the Torus (TFHE) procedure. A second such framework is the OpenFHE framework which supports multiple schemes including BGV, BFV, CKKS, TFHE, and FHEW.

The Concrete library is an open-source library developed in Rust that builds on the state-of-art TFHE cryptosystem. The Concrete library provides a user friendly interface making FHE easy to integrate. The Concrete library deals with inputs of arbitrary format and comes with an extensive set of operations for manipulating ciphertexts, including a programmable bootstrapping process. Learning With Errors (LWE) is a quantum robust method of cryptography applicable to FHE that is conjectured to be hard to solve, and thus is useful in cryptography.

Currently TFHE/Concrete Boolean operations require a series of bootstraps to eliminate noise from the computational routines performed on ciphertext. Bootstrapping is a computationally expensive process that involves performing a large number of transforms and matrix multiplications. Such transforms and matrix computations require a large amount of processing power for the necessary bootstrapping required for FHE supporting operations. The large number of operations for the bootstrap requires significant computational resources and time and thus impedes efficient encryption.

There is a need to implement an efficient encrypted execution of an LLM. There is another need for a more efficient process of encrypting LLM operations by reducing the number of bootstrapping steps.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

One disclosed example is a method to efficiently determine an attention function. A combined key and query matrix is calculated in plaintext. A ciphertext-plaintext matrix multiplication of the combined key and query matrix is performed with a ciphertext input. An output of the ciphertext-plaintext matrix multiplication of the combined key and query matrix is output. A ciphertext-plaintext matrix multiplication of a value matrix with the ciphertext input is performed. The ciphertext-plaintext matrix multiplication of the value matrix is bootstrapped.

A further implementation of the example method is where the ciphertext is generated via encryption performed via a Fully Homomorphic Encryption (FHE) process. Another implementation is where the attention function is part of a large language model. Another implementation of the example method includes performing a comparison function via ciphertext-ciphertext matrix multiplication (CCMM) on the ciphertext-plaintext matrix multiplication of the combined key and query matrix. A Softmax function is performed on the results of the CCMM. An output of the Softmax function is combined with the ciphertext-plaintext matrix multiplication of the value matrix.

Another disclosed example is a computer system including a memory and an input accepting an input to an attention head function. A processor is coupled to the input and the memory. The processor is configured to pre-calculate a combined key and query matrix in plaintext and storing the combined key and query matrix in the memory. The processor is configured to perform a ciphertext-plaintext matrix multiplication of the combined key and query matrix with a ciphertext input. The processor is configured to bootstrap an output of the ciphertext-plaintext matrix multiplication of the combined key and query matrix. The processor is configured to perform a ciphertext-plaintext matrix multiplication of a value matrix with the ciphertext input. The processor is configured to bootstrap the ciphertext-plaintext matrix multiplication of the value matrix.

A further implementation of the example computer system is where the processor includes a plurality of identical configurable processing cores and a network interconnecting the plurality of identical configurable processing cores. Another implementation is where the ciphertext is generated via encryption performed via a Fully Homomorphic Encryption (FHE) process. Another implementation is where the attention function is a part of a large language model. Another implementation is where the processor is further configured to perform a comparison function via ciphertext-ciphertext matrix multiplication (CCMM) on resulting ciphertext-plaintext matrix multiplication of the combined key and query matrix. The processor is further configured to perform a Softmax function on the results of the CCMM; and combine an output of the Softmax function with the ciphertext-plaintext matrix multiplication of the value matrix. Another implementation is where the attention head function is part of a transformer based large model.

Another disclosed example is a non-transitory computer readable medium including executable instructions which, when executed in a processor, causes the processor to pre-calculate a combined key and query matrix in plaintext. The instructions cause the processor to perform a ciphertext-plaintext matrix multiplication of the combined key and query matrix with a ciphertext input. The instructions cause the processor to bootstrap an output of the ciphertext-plaintext matrix multiplication of the combined key and query matrix. The instructions cause the processor to perform a ciphertext-plaintext matrix multiplication of a value matrix with the ciphertext input. The instructions cause the processor to bootstrap the ciphertext-plaintext matrix multiplication of the value matrix.

A further implementation of the example non-transitory computer readable medium is where the processor includes a plurality of identical configurable processing cores and a network interconnecting the plurality of identical configurable processing cores. Another implementation is where the ciphertext is generated via encryption performed via a Fully Homomorphic Encryption (FHE) process. Another implementation is where the attention function is a part of a large language model. Another implementation is where instructions cause the processor to perform a comparison function via ciphertext-ciphertext matrix multiplication (CCMM) on resulting ciphertext-plaintext matrix multiplication of the combined key and query matrix. The instructions cause the processor to perform a Softmax function on the results of the CCMM; and combine an output of the Softmax function with the ciphertext-plaintext matrix multiplication of the value matrix. Another implementation is where the attention head function is part of a transformer based large model.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure will be better understood from the following description of exemplary embodiments together with reference to the accompanying drawings, in which:

FIG. 1A is a diagram of a chip having four dies each having multiple processing cores;

FIG. 1B is a simplified diagram of one of the dies on the chip shown in FIG. 1A;

FIG. 2A is a block diagram of the array of cores in the die in FIG. 1B;

FIG. 2B is a three-dimensional view of the array of cores in the die in FIG. 1B;

FIG. 3A is a configuration for one of the cores in the example core array in FIG. 2B;

FIG. 3B is a set of configurations for multiple cores in the example core array in FIG. 2B;

FIG. 3C is a diagram of several dies mapped to a topology configured to perform different functions;

FIG. 4A is a block diagram of basic processing for an example LLM;

FIG. 4B is a detailed block diagram of the attention head function module in FIG. 4A;

FIG. 5A is a block diagram of the prior art attention head function module in FIG. 4B showing the bootstrapping required for encryption to protect the LLM;

FIG. 5B is a block diagram of an example system that reduces bootstrapping and matrix multiplications for an example LLM using encryption;

FIG. 6 shows the process of plaintext-ciphertext matrix multiplication (PCMM) or ciphertext-plaintext matrix multiplication (CPMM) for the process in FIG. 5B; and

FIG. 7 shows a prior art used in both the known method in FIG. 5A and the example method in FIG. 5B in which a PCMM or CPMM can be completed by performing two plaintext-plaintext matrix multiplications (PPMMs).

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements, and limitations that are disclosed, for example, in the Abstract, Summary, and Detailed Description sections, but not explicitly set forth in the claims, should not be incorporated into the claims, singly, or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure is directed toward efficiently determining an attention function of a large language model by pre-calculating a combined key and query matrix in plaintext, and performing a ciphertext-plaintext matrix multiplication of the combined key and query matrix with a ciphertext input. The output of the resulting ciphertext-plaintext matrix multiplication of the combined key and query matrix is bootstrapped. A ciphertext-plaintext matrix multiplication of the value matrix with the ciphertext input is performed. The resulting ciphertext-plaintext matrix multiplication of the value matrix is bootstrapped. Thus, this method eliminates the need for a bootstrap step thus increasing computational speed.

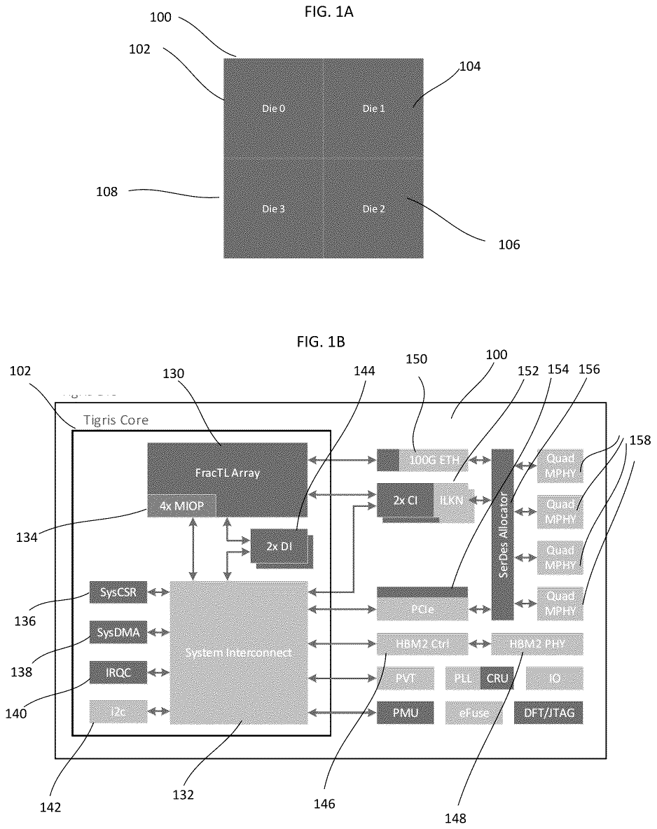

FIG. 1A shows an example chip 100 that is subdivided into four identical dies 102, 104, 106, and 108. Each of the dies 102, 104, 106, and 108 include multiple processor cores, support circuits, serial interconnections and serial data control subsystems. For example, the dies 102, 104, 106, and 108 may each have 4,096 processing cores as well as SERDES interconnection lanes to support different communication protocols. There are die to die parallel connections between the dies 102, 104, 106 and 108. Thus, each of the dies 102, 104, 106, and 108 in this example are interconnected by Interlaken connections. The chip 100 is designed to allow one, two or all four of the dies 102, 104, 106, and 108 to be used. The pins on a package related to un-used dies are left unconnected in the package or the board. The dies are scalable as additional chips identical to the chip 100 may be implemented in a device or a circuit board. In this example, a single communication port such as an Ethernet port is provided for the chip 100. Of course, other ports may be provided, such as one or more ports for each die.

FIG. 1B is a block diagram of one example of the die 102. The die 102 includes a fractal array 130 of processing cores. The processing cores in the fractal array 130 are interconnected with each other via a system interconnect 132. The entire array of cores 130 serves as the major processing engine of the die 102 and the chip 100. In this example, there are 4096 cores in the fractal array 130 that are organized in a grid.

The system interconnection 132 is coupled to a series of memory input/output processors (MIOP) 134. The system interconnection 132 is coupled to a control status register (CSR) 136, a direct memory access (DMA) 138, an interrupt controller (IRQC) 140, an I2C bus controller 142, and two die to die interconnections 144. The two die to die interconnections 144 allow communication between the array of processing cores 130 of the die 102 and the two neighboring dies 104 and 108 in FIG. 1A.

The chip includes a high bandwidth memory controller 146 coupled to a high bandwidth memory 148 that constitute an external memory sub-system. The chip also includes an Ethernet controller system 150, an Interlaken controller system 152, and a PCIe controller system 154 for external communications. In this example each of the controller systems 150, 152, and 154 have a media access controller, a physical coding sublayer (PCS) and an input for data to and from the cores. Each controller of the respective communication protocol systems 150, 152, and 154 interfaces with the cores to provide data in the respective communication protocol. In this example, the Interlaken controller system 152 has two Interlaken controllers and respective channels. A SERDES allocator 156 allows allocation of SERDES lines through quad M-PHY units 158 to the communication systems 150, 152 and 154. Each of the controllers of the communication systems 150, 152, and 154 may access the high bandwidth memory 148.

In this example, the array 130 of directly interconnected cores are organized in tiles with 16 cores in each tile. The array 130 functions as a memory network on chip by having a high-bandwidth interconnect for routing data streams between the cores and the external DRAM through memory IO processors (MIOP) 134 and the high bandwidth memory controller 146. The array 130 functions as a link network on chip interconnection for supporting communication between distant cores including chip-to-chip communication through an “Array of Chips” Bridge module. The array 130 has an error reporter function that captures and filters fatal error messages from all components of array 130.

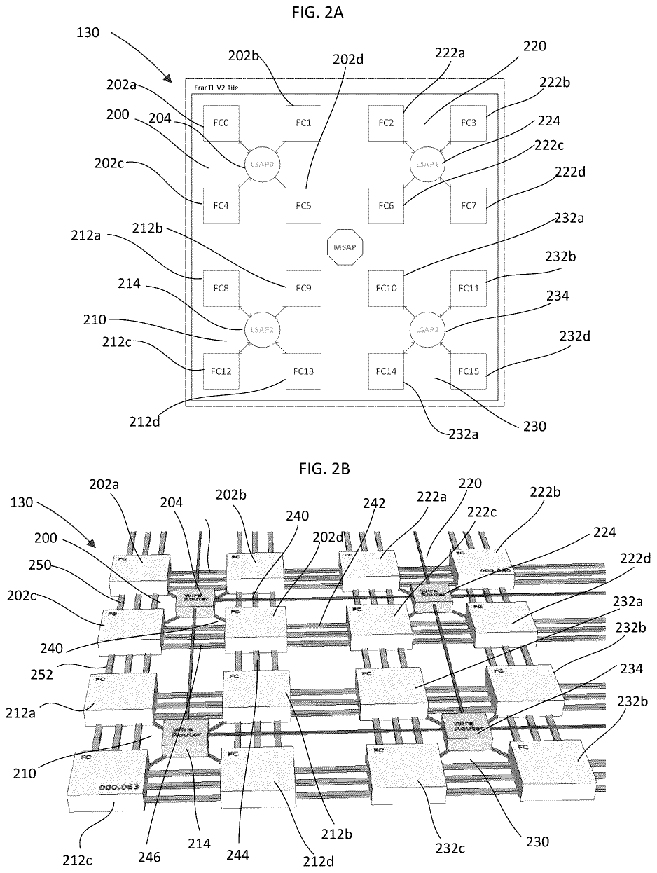

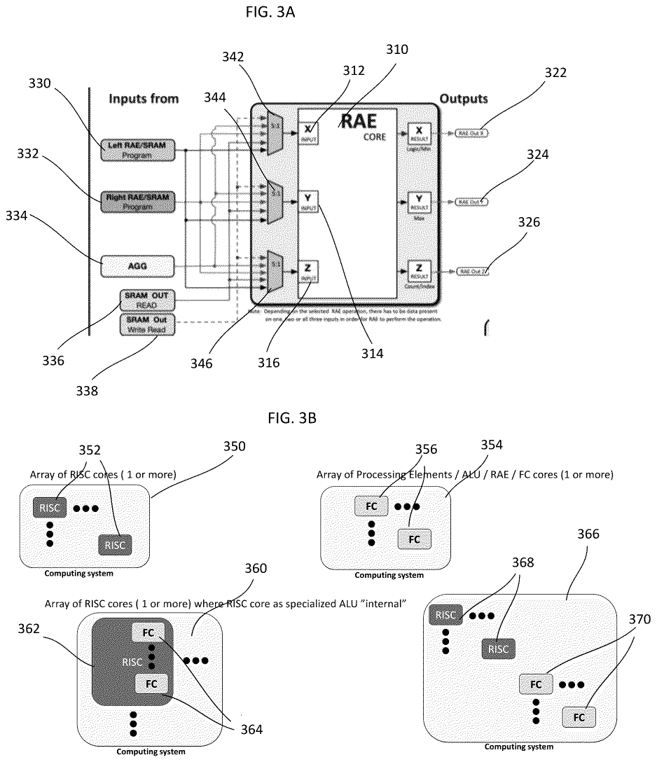

FIG. 2A is a detailed diagram of the array of cores 130 in FIG. 1B. FIG. 2B is a three-dimensional image of the array of cores 130 in FIG. 2B. The array of cores 130 is organized into four core clusters such as the clusters 200, 210, 220, and 230 shown in FIG. 3A. For example, the cluster 200 includes cores 202a, 202b, 202c, and 202d. Each of the four cores in each cluster 200 such as cores 202a, 202b, 202c, and 202d are coupled together by a router 204. FIG. 3B shows other clusters 210, 220, and 230 with corresponding cores 212a-212d, 222a-222d and 232a-232d and corresponding routers 214, 224, and 234.

As may be seen specifically in FIG. 2B, in this example, each of the cores 202a, 202b, 202c, and 202d has up to four sets of three interconnections [L, A, R]. For example, a core in the center of the array such as the core 202d includes four sets of interconnections 240, 242, 244, and 246 each connected to one of four neighboring cores. Thus, core 202b is connected to the core 202d via the interconnections 240, core 202c is connected to the core 202d via the interconnections 242, core 212b is connected to the core 202d via the interconnections 244, and core 202c is connected to the core 202d via the interconnectors 246. A separate connector 248 is coupled to the wire router 204 of the cluster 200. Thus, each core in the middle of the array, has four sets of interconnections, while border cores such as the core 202c only have three sets of interconnections 250, 252, and 246 that are connected to respective cores 202a, 202d, and 212a. In order to configure the cores of the example array 130 in FIG. 2A, the inputs of certain blocks may be changed to configure blocks for one of the three different function blocks. The functions may be configured by simply changing the inputs of the processing cores.

In order to configure the cores of the example array 130 in FIG. 1B, the inputs of certain blocks may be changed to configure blocks for one of the three different function blocks. The functions may be configured by simply changing the inputs of the processing cores. FIG. 3A shows a block diagram of an example processing core 300 that includes a reconfigurable arithmetic engine (RAE) 310. The RAE 310 may be configured and reconfigured to perform relevant mathematical routines such as matrix multiplications, point wise multiplication and nonlinear functions, such as layer normalization and a Softmax function, required in private LLM. The RAE 310 includes input reorder queues, a multiplier shifter-combiner network, an accumulator and logic circuits. The RAE 310 operates in several modes, such as operating as an ALU, and include a number of floating point and integer arithmetic modes, logical manipulation modes (Boolean logic and shift/rotate), conditional operations, and format conversion. The RAE 310 includes three inputs 312, 314, and 316 and three outputs 322, 324, and 326. The RAE 310 receives the output data from a program executed by another RAE 330 and output data from another program executed by another RAE 332. An aggregator (AGG) 334 provides an output of aggregated data from different sources to the RAE 310. A memory read output 336 and a memory write output 338 also provide data to the RAE 310. The memory outputs 336 and 338 provide access to a memory such as an SRAM that stores operand data, and optionally may also store configurations or other instructions for the RAE 310.

Each of the output data of the RAE 330, RAE 332, aggregator 334, memory read output 336 and the memory write output 338 are provided as inputs to three multiplexers 342, 344, and 346. The outputs of the respective multiplexers 342, 344, and 346 are coupled to the respective inputs 312, 314, and 316 of the RAE 310.

There are two versions of configuration of computational cores which can dynamically switch from one type to the other. A set of cores may be configured as a full RISC-V processor with associated SRAM able to execute traditional control flow programs as a function representing the computation within a dataflow node. RISC-V for Legacy code is supported by configuring multiple cores under software control. This may be used to produce software GPUs or other types of cores from the multiple cores. The processing cores such as the FracTLcores offered by Cornami are an efficient set of transistors for streaming data driven workloads, with a dynamic programming scheduler such as the TruStream programming scheduler offered by Cornami and memory, created from a set of RAE Cores. In this example, the FracTLcores can scale up to 64,000,000 cores across chips and systems at near linear scale. Combining the aspects of both data flow and reconfigurable computing to stream data, this architecture with highly functional computational elements can dynamically scale over many chips. It enables developers to take full advantage of both parallelism and pipelining to minimize processing latency and maximize overall application performance and throughput. The use of the architecture of processing cores results in reduction in processing cost. The cores may employ a data-flow programming model resulting in a 5× reduction in processing cost. A data-defining-function computation for the cores may result in a 6× reduction in processing cost. A data Read/Write with a Tensor pattern applied to the cores may result in a 6× reduction in processing cost.

FIG. 3B is a diagram of four configurations 350, 354, 360, and 366 of the array of cores in FIG. 1B as either a RISC-V processor or a specialized ALU internal module. The configurations 350, 354, 360, and 366 can dynamically switch from one type to the other by reconfiguring some or all of the computational cores in the configurations. The first configuration 350 is a set of cores configured as a full RISC processor with associated SRAM able to execute traditional Control Flow programs as a function representing the computation within a dataflow node. In this example, the RISC processor includes sixteen separate cores 352. Another configuration 354 is sixteen independently reconfigurable and programmable ALUs, that are each cores 356 (termed FracTLcores® available from Cornami in this example). Each of the cores 356 have associated SRAM supporting multiple simultaneous integer and floating point computations of up to 128-bits. The configuration 354 thus is a set of cores that are configured as individual FracTLcores. The configuration 360 includes one or more RISC cores 362 that are a set of sixteen cores in this example. The RISC core 362 can have additional individual or multiple FracTLcores 364 incorporated within them to accelerate specific RISC functions. Alternatively, the additional cores 364 may be designated for data path/arithmetic acceleration, enhancing ALU performance.

Thus, to implement a standard 64 bit RISC processor such as the RISC-V processor in this example, sixteen cores are configured to become the RISC-V. Optional additional cores may be added to the configuration to provide hardware acceleration to math operations performed by the RISC. For example, a normal RISC processor does not have hardware to perform a cosine function. Thus, an additional core may be added and configured to perform a hardware cosine operation. This enhances the ISA instruction set of the RISC processor by adding the hardware accelerated cosine function that may be accessed by the RISC processor. The configuration 366 has a set of cores that is configured into two individual groupings of cores configured as RISC processors 368 and cores that are configured as ALUs (e.g., FracTLcores) 370.

FIG. 3C is a block diagram of an example architecture 380 of scaling circuits using four integrated circuits 382, 384, 386, and 388 that are coupled to memory controllers and external memories. The integrated circuits 382, 384, 386, and 388 may be formed on a die and each include an array of cores described above in reference to FIGS. 2-3A. Each of the individual integrated circuits 382, 384, 386, and 388 are connected to each other using SERDES interconnections 390 to produce larger computational fabrics. Each core may be individually configured such as those configurations shown in FIG. 3A. The cores are interconnected via the network on chip components shown in FIGS. 2A-2B. Each of the integrated circuits 382, 384, 386, and 388 also include input/output interconnections 392 that may be controlled by a memory controller such as the memory input/output processors 134 in FIG. 2B to manage a connected high bandwidth memory devices such as an HBM die 394 integrated on a chip that includes the integrated circuits or off chip.

A topology 396 of a configuration of the integrated circuits 382, 384, 386, and 388 is also shown in FIG. 3C. The topology 396 is a graph of functions and interconnections for data and control flow through the configured cores of the integrated circuits 382, 384, 386, and 388. Each box in the topology 396 represents a fractal core in one of the integrated circuits 382, 384, 386, and 388. The topology 396 is placed into multiple integrated circuits that such as integrated circuits 382, 384, 386, and 388 that make up a computational fabric. The topology 396 may thus be mapped to the cores of the integrated circuits 382, 384, 386, and 388. In this example, a set of cores in the integrated circuits 382 and 384 may be configured for concurrent operations such as in a first area of the topology 396. The cores in the other integrated circuits 386 and 388 may be configured for parallelism in an ultra deep pipeline such as in another area of the topology 396.

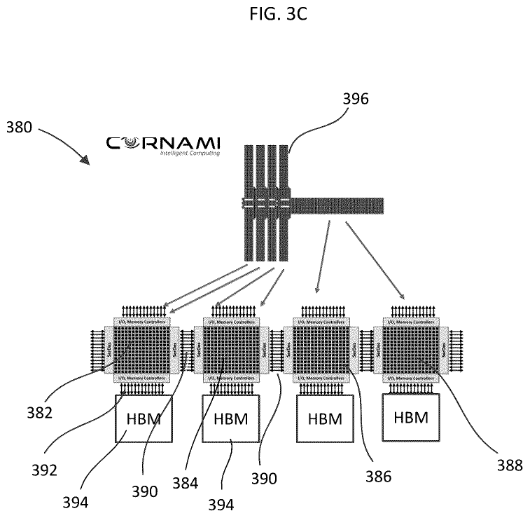

FIG. 4A is a diagram of a system 400 for executing an LLM. An LLM may be considered as a nonlinear mapping from the input X (a query) and to output Y (a response) by performing the following major processing blocks shown in FIG. 4. The major processing blocks thus include an Embedding and Encoding block 410, multiple Head Attention function blocks 412, a Feed Forward Perceptron 414, a Layer Normalization block 416, and a Softmax function block 418. The Embedding and Encoding block 410 is a pre-processing unit which mainly performs the matrix multiplications between the input matrix and the corresponding weight matrices. The multiple Head Attention functions 412 perform multiple matrix multiplications according to three weight matrices called a Query Weight Matrix 420, a Key Weight Matrix 422, and a Value Weight Matrix 424, respectively. The Feed Forward Perceptron layers 414 constitute a conventional feedforward neural network having at least one hidden layer. The Layer Normalization block 416 simply normalizes each input. The Softmax function block 418 is an activation function that scales numbers/logits into probabilities.

The output of an LLM can uniquely be generated by all the pre-determined weight matrices and its inputs. These weight matrices can be obtained during an off-line training stage. During an inference stage, the LLM simply performs all the above matrix multiplications and corresponding nonlinear functions such as layer normalization and Softmax operations. Different LLMs have different parameter sizes (the total element number of the weight matrices), which mainly depend on the numbers of attention heads and number of LLM layers. For example, GPT-3 has 96 heads and 96 layers and hence there are about 175 billion parameters (elements of weight matrices) in total.

FIG. 4B is a detailed diagram of a known system to execute the attention head functions 112 of the LLM system 400 in FIG. 4A. An input 430 is derived from the embedded and encoded query 410 in FIG. 4A. The input 430 is fed to perform plaintext-plaintext matrix multiplication (PPMM) with the Query weight Matrix 420, the Key weight Matrix 422, and the Value weight Matrix 424 to produce a query matrix 440, a key matrix 442, and a value matrix 444. The query matrix 440 and the key matrix 442 generate a new comparison function matrix 450 between query weights and key weights by performing a PPMM. The output matrix 450 of the PPMM is then provided to a Softmax function 452. The output of the Softmax function 452 is fed into a temperature operation 454 together with the value matrix 444. Through a PPMM, the output of temperature operation 454 multiplies with a weight matrix 460 and then is sent to the feedforward neural network 414.

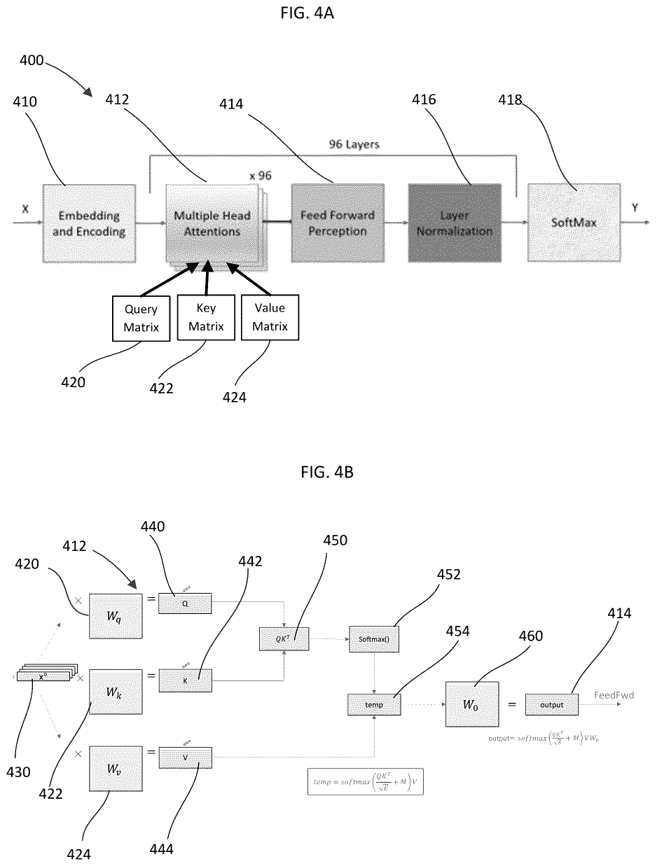

In order to maintain security, various stages of the LLM need to be encrypted and various bootstrapping steps need to be performed. FIG. 5A is a detailed diagram of an attention layer for the LLM in FIG. 4B that performs the attention head processing in the encrypted domain. In FIG. 5A, an input 430 is derived from the encrypted, embedded and encoded query 410 in FIG. 4A. The encrypted input 430 is input to perform ciphertext-plaintext matrix multiplication (CPMM) with the Query weight Matrix 420, the Key weight Matrix 422, and the Value weight Matrix 424 to produce a respective ciphertext query matrix 440, a ciphertext key matrix 442, and a ciphertext value matrix 444. As shown FIG. 5A, bootstrapping 510 needs to be performed on the ciphertext query matrix 440, and bootstrapping 512 needs to be performed on the ciphertext key matrix 442 before being fed into ciphertext-ciphertext matrix multiplication (CCMM) 450. The output of CCMM 450 needs to be bootstrapped 520 before being provided to the Softmax function 452. The output of the Softmax function 452 and the ciphertext value matrix 444 are bootstrapped 522 and 524, respectively, before being provided to the temperature operation CCMM 454. The output of the temp operation CCMM 454 is bootstrapped 524 and then a CPMM 530 is performed with weights W₀. The output of CPMM 530 is again bootstrapped 532 before being sent to the feedforward neural network 414.

If the following denotations for FIG. 5A are used:

$$x ∈ {R}^{n \times L} {W}_{q} , {W}_{k} ∈ {R}^{L \times L}$$

where x is the encrypted input token and W_{q} and Wₖ are the plaintext query weight matrix 420 and plaintext key weight matrix 422, respectively, the following are the more detailed CPMM and CCMM formulations in order to get the ciphertext query matrix 440, the ciphertext key matrix 442 and output of the comparison function of CCMM 450.

$$CPMM Q = x {W}_{q} noise : {n}_{q} ( One Bootstrapping )$$

$$CPMM K = x {W}_{k} noise : {n}_{k} ( One Bootstrapping )$$

$$CCMM {QK}^{T} noise : {n}_{q} K + {n}_{k} Q + {n}_{q} {n}_{k} ( One Bootstrapping )$$

Thus to get the desired output of CCMM 450 in the known system FIG. 5A, two CPMMs, one CCMM, and three total evaluations/bootstrapping steps (510, 512 and 520) are needed to perform in an online stage. In addition, 1 encoding, 1 encryption, and 2 matrix packing steps are needed to be performed in an offline stage. The computations in the offline stage are much less time-critical than those in the online stage.

FIG. 5B shows the example method to reduce complexity (matrix computations and bootstrapping) for the encrypted version of the attention head function layer in FIG. 4B. In this example, a new combined query and key weight matrix W_{qk} is first pre-calculated according to the Query weight Matrix 420, and the Key weight Matrix 422, that is,

$${W}_{qk} = {W}_{q} {W}_{k}^{T}$$

The pre-calculation may occur prior to the other more time-sensitive steps thus allowing compute resources to be directed toward such steps. The pre-calculated combined query and key weight matrix may be stored in a memory to be available for performance of the subsequent steps. The encrypted input 430 is fed to perform CPMM with the new weight matrix W_{qk} and then to get the ciphertext output 542 of CPMM 540. As shown in FIG. 5B, bootstrapping 550 needs to be performed on the output 542 before being fed into CCMM 450. Unlike FIG. 5A where the other input of CCMM 450 comes from the output of the ciphertext key matrix 442, the other ciphertext input of CCMM 450 in FIG. 5B directly comes from the encrypted input 430 by eliminating the CPMM 422 and the bootstrapping 512 in FIG. 5A. However, the ciphertext output of CCMM 450 in FIG. 5B equals to the ciphertext output of CCMM 450 in FIG. 5A. The remaining processing in FIG. 5B is the exact same as that shown in FIG. 5A.

The following shows the method in FIG. 5B provides the same output of the CCMM 450 as that in FIG. 5A. More specifically, the output of CCMM 450 in FIG. 5A can be written as

$$Q {K}^{T} = ( x {W}_{q} {W}_{k}^{T} ) {x}^{T}$$

The output of the CCMM 450 in FIG. 5B is

$$x {W}_{q k} {x}^{T} = {W}_{q} {W}_{k}^{T} {W}_{q k} ∈ {R}^{L \times L} ( even if {W}_{q} , {W}_{k} ∈ {R}^{L \times q} )$$

Replacing W_{qk} with

$${W}_{q} {W}_{k}^{T}$$

yields

$$x {W}_{q k} {x}^{T} = x {W}_{q} {W}_{k}^{T} = Q {K}^{T}$$

where W_{qk}∈R^{L×L} (even if W_{q}, Wₖ∈R^{L×q}). The above concludes the proof. In other words, to get the ciphertext output of CCMM 450 in the example method, the following computation and corresponding bootstrapping needs to be followed:

$$CPMM : {xW}_{q k} = x {W}_{q} {W}_{k}^{T} {n}_{q k} noise : {n}_{qk} ( one Bootstrapping )$$

$$CCMM {QK}^{T} = ( x {W}_{q} {W}_{k}^{T} ) {x}^{T} noise : {n}_{q k} x ( one Bootstrapping )$$

which means that only one CPMM, one CCMM and only two evaluations/bootstrappings (steps 550 and 520) are needed to perform in online stage. This results in a reduction in computational requirements by eliminating one CPMM and one bootstrapping step.

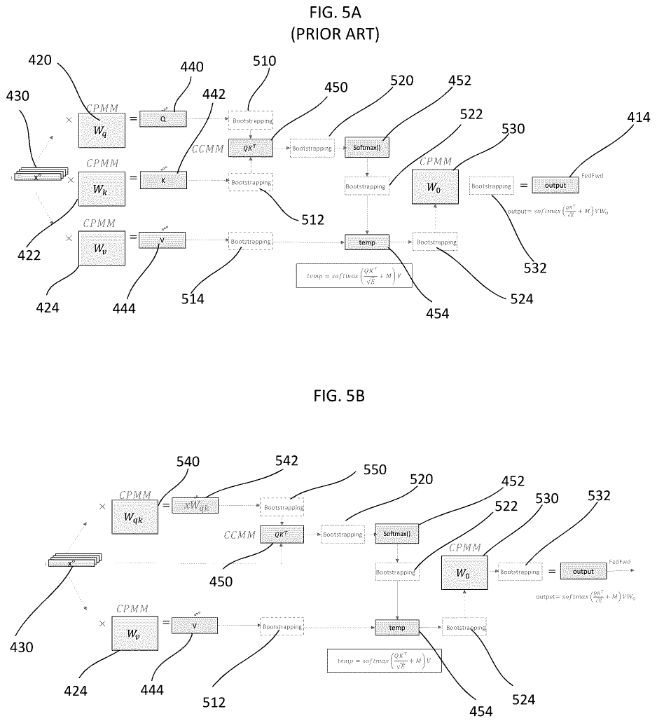

FIG. 6 shows a diagram of a known method for performing a CPMM or PCMM in FIGS. 5A and 5B. In this example, a plaintext matrix 610 is multiplied by an encrypted matrix 620 to produce an encrypted output matrix 630. In other words, all CPMM blocks in FIG. 5B such as the CPMM 540 can be performed by the example method illustrated in FIG. 6 where the plaintext matrix 610 takes the plaintext matrix part of the CPMM 540 (W_{qk}) in FIG. 5A, and the encrypted matrix 620 takes the ciphertext part of the CPMM 540 (that is, the encrypted input matrix 430).

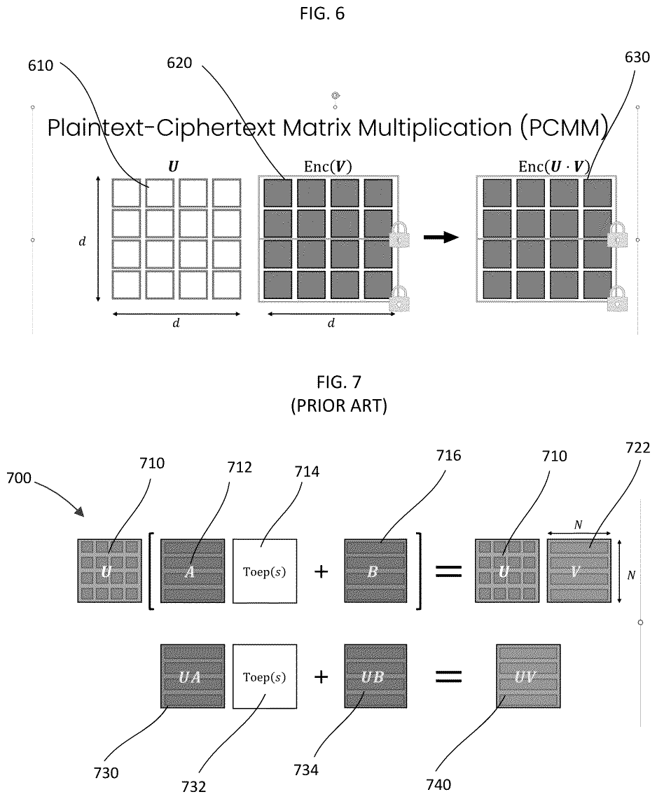

FIG. 7 shows a diagram 700 of another known method for performing PCMM or CPMM by decomposing into two PPMMs. More specifically, ciphertext matrix V 722 consists of plaintext matrix A 712 and plaintext matrix B 716 as well as a key matrix 714. The first PCMM is performed on a plaintext matrix U 710 and the plaintext matrix A 712 to get new matrix UA 730. The second PCMM is performed on the plaintext matrix U 710 and the plaintext matrix B 716 to get the new matrix UB 734. Afterward, using the key matrix 732, the desired PCMM output: matrix UV 740 may be obtained. As indicated in the above for FIG. 6, all the CPMM blocks in FIG. 5B such as CPMM 540 can also be performed by the method shown in FIG. 7, where the plaintext matrix U 710 takes the plaintext matrix part of the CPMM 540 (W_{qk}) and the plaintext matrix A 712 and plaint text matrix B 716 take two matrices, which form the ciphertext matrix of CPMM 540 (the encrypted input matrix 430).

Although the attention function example above relates to large language models, the example method may be applied to any transformer based large model.

As explained above, the above explained method may be implemented on an example non-transitory computer readable medium including executable instructions which, when executed in a processor, causes the processor to perform the matrix decomposition and other functions in FIG. 5B. The computer readable medium may be high bandwidth memory or the internal memory of the configured cores in FIGS. 2-3A themselves. The processor may be a set of the array of cores that may be configured through the executable instructions that allow configuration of the cores as well as routing of data and instructions through the network on chip.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A method to efficiently determine an attention function, the method comprising:
pre-calculating a combined key and query matrix in plaintext;
performing a ciphertext-plaintext matrix multiplication of the combined key and query matrix with a ciphertext input;
bootstrapping an output of the ciphertext-plaintext matrix multiplication of the combined key and query matrix;
performing a ciphertext-plaintext matrix multiplication of a value matrix with the ciphertext input; and
bootstrapping the ciphertext-plaintext matrix multiplication of the value matrix.

2. The method of claim 1, wherein the ciphertext is generated via encryption performed via a Fully Homomorphic Encryption (FHE) process.

3. The method of claim 1, wherein the attention function is part of a large language model.

4. The method of claim 1, further comprising:
performing a comparison function via ciphertext-ciphertext matrix multiplication (CCMM) on the ciphertext-plaintext matrix multiplication of the combined key and query matrix;
performing a Softmax function on the results of the CCMM; and
combining an output of the Softmax function with the ciphertext-plaintext matrix multiplication of the value matrix.

5. The method of claim 1, wherein the attention function is part of a transformer based large model.

6. A computer system comprising:
a memory;
an input accepting an input to an attention head function;
a processor coupled to the input and the memory, the processor configured to:
pre-calculate a combined key and query matrix in plaintext and storing the combined key and query matrix in the memory;
perform a ciphertext-plaintext matrix multiplication of the combined key and query matrix with a ciphertext input;
bootstrap an output of the ciphertext-plaintext matrix multiplication of the combined key and query matrix;
perform a ciphertext-plaintext matrix multiplication of a value matrix with the ciphertext input; and
bootstrap the ciphertext-plaintext matrix multiplication of the value matrix.

7. The computer system of claim 6, wherein the processor includes a plurality of identical configurable processing cores and a network interconnecting the plurality of identical configurable processing cores.

8. The computer system of claim 6, wherein the ciphertext is generated via encryption performed via a Fully Homomorphic Encryption (FHE) process.

9. The computer system of claim 6, wherein the attention function is a part of a large language model.

10. The computer system of claim 6, wherein the processor is further configured to:
perform a comparison function via ciphertext-ciphertext matrix multiplication (CCMM) on resulting ciphertext-plaintext matrix multiplication of the combined key and query matrix;
perform a Softmax function on the results of the CCMM; and
combine an output of the Softmax function with the ciphertext-plaintext matrix multiplication of the value matrix.

11. The computer system of claim 6, wherein the attention head function is part of a transformer based large model.

12. A non-transitory computer readable medium including executable instructions which, when executed in a processor, causes the processor to:
pre-calculate a combined key and query matrix in plaintext;
perform a ciphertext-plaintext matrix multiplication of the combined key and query matrix with a ciphertext input;
bootstrap an output of the ciphertext-plaintext matrix multiplication of the combined key and query matrix;
perform a ciphertext-plaintext matrix multiplication of a value matrix with the ciphertext input; and
bootstrap the ciphertext-plaintext matrix multiplication of the value matrix.

13. The non-transitory computer readable medium of claim 12, wherein the processor includes a plurality of identical configurable processing cores and a network interconnecting the plurality of identical configurable processing cores, wherein the instructions configure the configurable processing cores.

14. The non-transitory computer readable medium of claim 12, wherein the ciphertext is generated via encryption performed via a Fully Homomorphic Encryption (FHE) process.

15. The non-transitory computer readable medium of claim 12, wherein the executable instructions cause the processor to:
perform a comparison function via ciphertext-ciphertext matrix multiplication (CCMM) on resulting ciphertext-plaintext matrix multiplication of the combined key and query matrix;
perform a Softmax function on the results of the CCMM; and
combine an output of the Softmax function with the ciphertext-plaintext matrix multiplication of the value matrix.
